(19) United States
(12) Patent Application Publication
(10) Pub. No.: US 2021/0224774 A1
(43) Pub. Date: Jul. 22, 2021

(54) SYSTEMS AND METHODS FOR MANAGING ELECTRONIC RECEIPTS OF A POINT OF SALE TERMINAL

(71) Applicant: Robert Jonathan SCHOK, North York (CA)

(72) Inventor: Robert Jonathan SCHOK, North York (CA)

(21) Appl. No.: 16/748,003

(22) Filed: Jan. 21, 2020

(51) Int. Cl. G06Q 20/20; G06Q 20/32; G06Q 20/34; G06Q 20/40; G06Q 40/02; G06F 21/60

(52) U.S. Cl. CPC G06Q 20/209; G06Q 20/204; G06Q 20/3278; G06Q 2220/00; G06Q 20/40; G06Q 40/02; G06F 21/602; G06Q 20/341

(57) ABSTRACT

A payment system for managing electronic receipts of a payment terminal. The payment terminal includes a communication subsystem including a Near Field Communication (NFC) subsystem, a memory, and a processor configured to: complete a purchase transaction, establish, through the communication subsystem, a NFC session, and transmit, through the NFC session, receipt data of a receipt for the purchase transaction. The payment system includes a wireless communication device configured to establish, with the payment terminal, the NFC session, receive, from the payment terminal, receipt data of a receipt of a purchase transaction through the NFC session; and store the receipt data in memory.

### TECHNICAL FIELD

Example embodiments generally relate to systems and methods for managing electronic receipts of a point of sale terminal, for example receipts received by a wireless communication device.

### BACKGROUND

Typical purchase transactions involve a customer providing cash or a payment card to a retailer to purchase goods and services. The merchant, after receiving the payment, typically prints a paper receipt and provides the customer with the paper receipt.

In some electronic based payment systems, a touch screen is used to receive entry of an e-mail address or short-message-service (SMS) telephone number by the customer, after which the receipt is electronically sent to the customer's e-mail address or SMS telephone. Such a system is reliant on sending the receipt through intermediary servers or services.

There is a need for efficient systems and methods for managing electronic receipts.

### SUMMARY

Example embodiments relate to payment systems, devices and methods for communicating, managing and storing receipt data of a receipt.

An example embodiment is a system comprising; a payment terminal including a comprising: a communication subsystem including a Near Field Communication (NFC) subsystem; a memory; and a processor in communication with the communication subsystem and the memory and configured to: complete a purchase transaction, establish, through the communication subsystem, a NFC session, and transmit, through the NFC session, receipt data of a receipt for the purchase transaction.

In an example embodiment of any of the above, the processor is further configured to: receive payment information for the completing the purchase transaction; transmit, to a payment processor via the communication subsystem, the payment information for the complete the purchase transaction; and receive, via the communication subsystem, a confirmation that the purchase transaction is authorized from the payment processor.

In an example embodiment of any of the above, the processor is further configured to receive the payment information during a first NFC session, and transmit the receipt data during a second NFC session, separate from the first NFC session.

In an example embodiment of any of the above, the transmitting of the receipt data is not transmitted via the payment processor.

In an example embodiment of any of the above, the payment terminal further comprises a speaker, and the processor is further configured to output an audio output through the speaker in response to the receipt data being successfully transmitted.

In an example embodiment of any of the above, the payment terminal further comprises a speaker, and the processor is further configured to output an audio output through the speaker in response to establishing the NFC session.

In an example embodiment of any of the above, the NFC session is established with a wireless communication device.

Another example embodiment is a system comprising: a wireless communication device including: a communication subsystem, a memory; and a processor in communication with the communication subsystem and the memory and configured to: establish, with a payment terminal, a Near Field Communication (NFC) session via the communication subsystem, receive, from the payment terminal, receipt data of a receipt of a purchase transaction through the NFC session, and store the receipt data in the memory.

In an example embodiment of any of the above, the processor is further configured to, in order to establish the NFC session, detect whether the communication subsystem is within a threshold distance of the payment terminal.

In an example embodiment of any of the above, the processor is further configured to: transmit, to the payment terminal via the communication subsystem, payment information to complete the purchase transaction; and receive, via the communication subsystem, a confirmation that the purchase transaction is authorized from the payment terminal.

In an example embodiment of any of the above, the processor is further configured to generate the receipt from the receipt data, wherein the storing the receipt data includes storing the receipt.

In an example embodiment of any of the above, the receipt data is the receipt.

In an example embodiment of any of the above, the NFC session is established with a payment terminal.

In an example embodiment of any of the above, the wireless communication device is a smart card having a chip that includes the memory, the processor and the NFC subsystem.

Another example embodiment is a method performed by a wireless communication device, comprising: establishing, with a payment terminal, a Near Field Communication (NFC) session; receiving, from the payment terminal, receipt data of a receipt of a purchase transaction through the NFC session; and storing the receipt data in memory of the wireless communication device.

In an example embodiment of any of the above, the establishing of the NFC session includes detecting whether the wireless communication device is within a threshold distance of the payment terminal.

In an example embodiment of any of the above, the method further comprises transmitting, to the payment terminal, payment information in order to complete the purchase transaction; and receiving a confirmation that the purchase transaction is authorized from the payment terminal.

In an example embodiment of any of the above, the transmitting the payment information is performed during a first NFC session, and the transmitting the request for the receipt data is performed during a second NFC session separate from the first NFC session.

In an example embodiment of any of the above, the method further comprises transmitting the receipt data to a cloud server.

In an example embodiment of any of the above, the receipt data includes an image of the receipt.

In an example embodiment of any of the above, the receipt data includes markup language data for generating an image of the receipt.

In an example embodiment of any of the above, the receipt data comprises a transaction amount, a transaction location, a transaction type, a list of one or more goods or services, a card name, an account type, and a reference number.

In an example embodiment of any of the above, the receipt data is stored separate from a payment application which stores the payment information.

In an example embodiment of any of the above, the method further comprises encrypting the receipt data prior to storing the receipt data.

In an example embodiment of any of the above, the method further comprises generating the receipt from the receipt data, wherein the storing the receipt data includes storing the receipt.

In an example embodiment of any of the above, the wireless communication device is a smart card having a chip that includes the memory, a processor and a NFC subsystem.

Another example embodiment is a method performed by a payment terminal, comprising: completing a purchase transaction; establishing, through a communication subsystem, a Near Field Communication (NFC) session; and transmitting, through the NFC session, receipt data of a receipt for the purchase transaction.

In an example embodiment of any of the above, the NFC session is established with a wireless communication device.

In an example embodiment of any of the above, the completing the purchase transaction comprises: receiving, from a wireless communication device, payment information; transmitting, to a payment processor, the payment information; and receiving, from the payment processor, confirmation that the purchase transaction is authorized.

In an example embodiment of any of the above, receiving the payment information occurs during a first NFC session, and transmitting the receipt data occurs during a second NFC session, separate from the first NFC session.

In an example embodiment of any of the above, the receipt data comprises a transaction amount, a transaction location, a transaction type, a list of one or more goods or services, a card name, an account type, and a reference number.

In an example embodiment of any of the above, the receipt data transmitted to the wireless communication device is receipt data that is immediately available to be output by the payment terminal.

In an example embodiment of any of the above, the method further comprises, in response to the receipt data being successfully transmitted, outputting an audio output through a speaker.

In an example embodiment of any of the above, the method further comprises, in response to successfully establishing the NFC session and transmitting the receipt data, outputting an audio output through a speaker.

In an example embodiment of any of the above, the purchase transaction includes a banknote transaction.

### BRIEF DESCRIPTION OF THE DRAWINGS

For a more complete understanding of example embodiments, reference is now made to the following detailed description of example embodiments taken in conjunction with the accompanying drawings, in which:

FIG. 1 is a schematic block diagram of a payment system in accordance with an example embodiment.

FIG. 2 is a flow diagram showing messages using the payment system of FIG. 1 to receive receipts in accordance with an example embodiment.

FIG. 3 is a flow diagram performed by the wireless communication device of FIG. 1 operating to receive receipts in accordance with various example embodiments.

FIG. 4 is a block diagram illustrating an example point of sale terminal in accordance with example embodiments

FIG. 5 is a block diagram illustrating an example wireless communication device in accordance with example embodiments.

The same reference numbers may have been used in the drawings and the following detailed description of example embodiments to refer to similar elements.

### DETAILED DESCRIPTION OF EXAMPLE EMBODIMENTS

In some existing payment systems, the customer enters an e-mail address or short-message-service (SMS) telephone number, and the payment system sends an electronic receipt to the customer's e-mail address or SMS telephone number.

Example embodiments relate to systems and methods for managing receipt data of a point of sale terminal. In example embodiments, the systems and methods for managing receipts of a point of sale terminal include providing a receipt or receipt data directly to a customer device via a Near Field Communication (NFC) session, without the need for sending the receipt through intermediary servers or messaging services. As understood in the art, NFC is a set of communication protocols that enable two electronic devices to establish communication when the electronic devices are within a short range of each other.

An example embodiment is a payment system for managing electronic receipts of a payment terminal. The payment terminal includes a communication subsystem including a Near Field Communication (NFC) subsystem, a memory, and a processor configured to: complete a purchase transaction, establish, through the communication subsystem, a NFC session, and transmit, through the NFC session, receipt data of a receipt for the purchase transaction. The payment system includes a wireless communication device configured to establish, with the payment terminal, the NFC session, receive, from the payment terminal, receipt data of a receipt of a purchase transaction through the NFC session; and store the receipt data in memory.

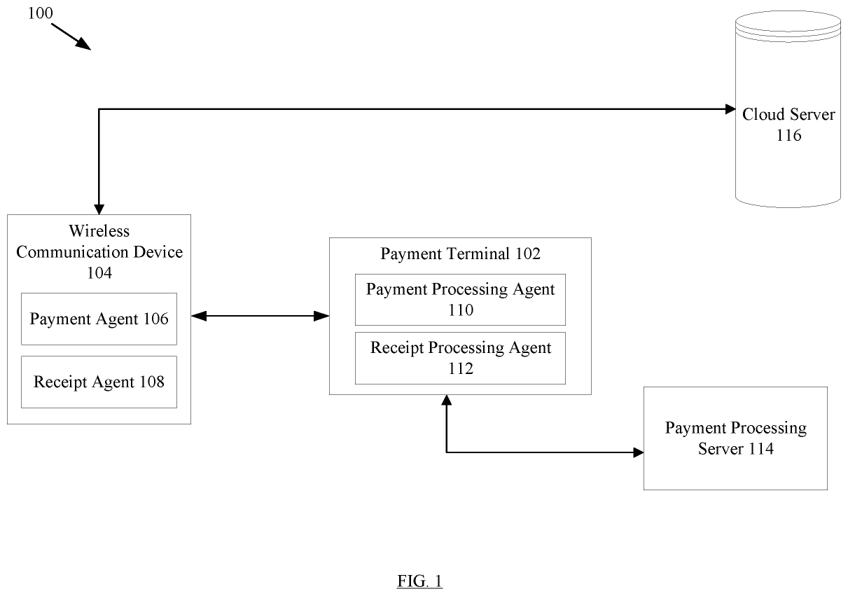

Reference is now made to FIG. 1, which shows a schematic block diagram of an example embodiment of a payment system 100. The payment system 100 includes a payment terminal 102 (also referred to as a point of sale (POS) terminal), a wireless communication device 104, and a payment processing server 112. In some examples, the system 100 can include a payment processing server 114. The payment terminal 102 in the payment system 100 is configured to manage receipts pursuant to purchase transactions, and may be configured to complete purchase transactions.

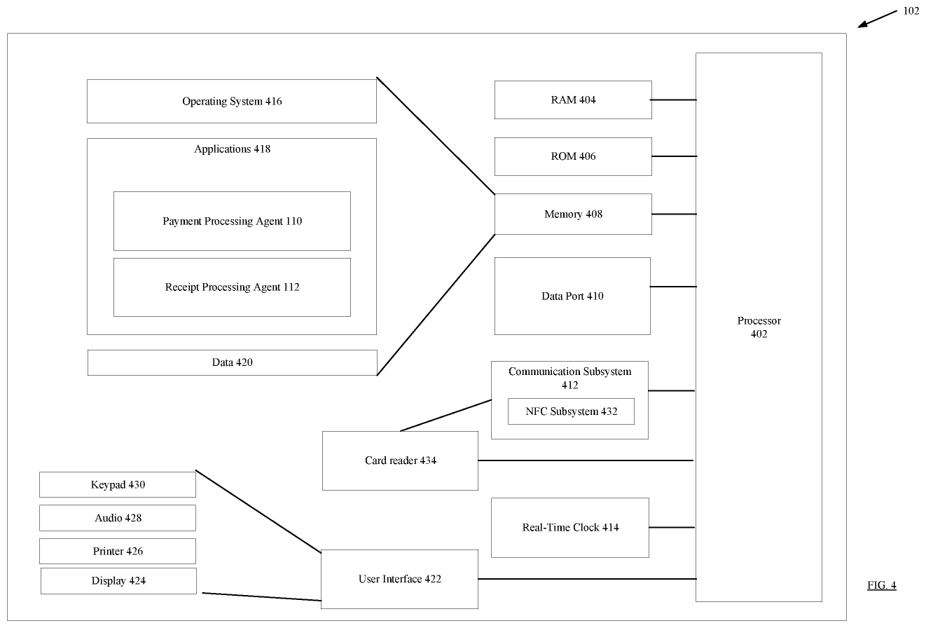

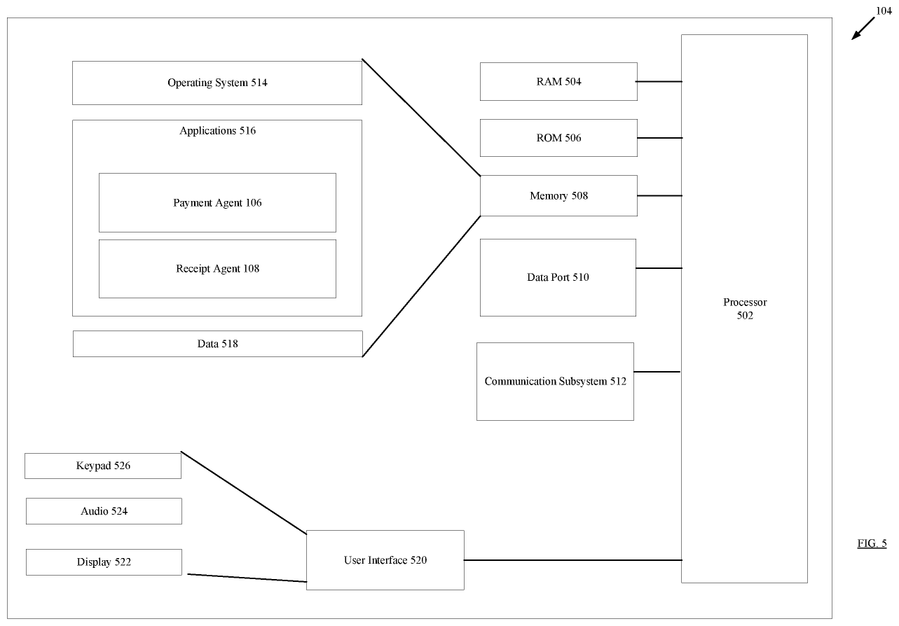

In an example embodiment, the payment terminal 102, in order to manage receipts pursuant to a purchase transaction, can transmit receipt data of a receipt in relation to the purchase transaction to the wireless communication device 104. For example, the payment terminal 102 can be configured to, through a communication subsystem 412 (FIG. 4), establish the NFC session with the wireless communication device 104 communication subsystem 512 (FIG. 5). The payment terminal 102 can subsequently transmit to the wireless communication device 104, through the NFC session, the receipt data of the purchase transaction. In example embodiments, the payment terminal 102 transmitting the receipt data to the wireless communication device 104 is the only receipt data that is output by the payment terminal 102. In such example embodiments, for example, paper receipts or email receipts are not required.

In example embodiments, other suitable protocols capable of receipt data are used to establish a wireless connection between the payment terminal 102 and the wireless communication device 104. NFC is a peer-to-peer communication protocol that does not require an intermediary device, server or network.

The wireless communication device 104 can similarly be configured to establish an NFC session with the payment terminal 102. After establishing the NFC session, the wireless communication device 104 can be configured to receive, through the NFC session, receipt data of the purchase transaction.

Establishing the NFC session may include the wireless communication device 104, or the payment terminal 102, or both, detecting whether the wireless communication device 104 is within a distance threshold of the payment terminal 102, which can be referred to as a “tap” action or a “transmit” action. The distance threshold may be determined by the protocol requirements for the NFC session to be established reliably, or otherwise. An example distance threshold is 1 cm, and in other examples is less than 1 cm. Another example distance threshold is physical touching between the wireless communication device 104 and the payment terminal 102, which is a distance threshold of zero (0 cm or near 0 cm).

In some example embodiments, in response to establishing an NFC session with the payment terminal 102, the wireless communication device 104 can be configured to transmit a request for receipt data. For example, the wireless communication device 104 can be preconfigured to request receipt data in every instance of establishing an NFC session with a payment terminal 102. In example embodiments, the wireless communication device 104 can be preconfigured to request receipt data pursuant to preconfigured rules, for example only at certain retailers, particular locations, and so forth.

In some examples, the wireless communication device 104 can prompt, via a user interface 520 (as described in FIG. 5), for a request for the receipt data. Upon receiving, via the user interface, the request for the receipt data, the wireless communication device 104 can be configured to transmit the request for the receipt data to the payment terminal 102.

In some examples, the wireless communication device can transmit a request for receipt data in response to receiving confirming user input prior to transmitting the request for the receipt data. For example, the wireless communication device 104 can prompt a user, via a user interface for user input to request the receipt data. The wireless communication device 104 can be configured to request the receipt data only upon receipt of confirming user input to request receipt data.

Similar to the wireless communication device 104, the payment terminal 102 can be configured to transmit the receipt data automatically in response to establishing a wireless connection with the wireless communication device 104, or in response to user input, or pursuant to a predetermined configuration.

The payment terminal 102 can provide the receipt data simultaneously, or near simultaneously, with the completion of the purchase transaction. For example, when a customer pays for a good or service utilizing the payment terminal 102, the payment terminal 102 can be configured to simultaneously or near simultaneously transmit the receipt data in response to receiving the authorization to complete the purchase transaction.

In example embodiments, the payment terminal 102 transmits the receipt data, via a NFC session, prior to, or subsequent to the purchase transaction being completed. For example, in certain scenarios, a retailers or customers obligation pursuant to the purchase transaction is completed prior to or subsequent to the purchase transaction being completed. For example, the purchase transaction can be a transaction that requires the customer to pay a deposit in order to complete, with the delivery of the goods or services to the customer occurring after payment has been completed.

In example embodiments, payment terminal 102 transmits the receipt data in response to receiving request for the receipt data prior. For example, the payment terminal 102 may receive a request for receipt data from the wireless communication device 104.

In example embodiments, the purchase transaction contains elements which are not the responsibility of the payment terminal 102 or the wireless communication device 104. In some examples, the purchase transaction may be a banknote transaction. For example, the purchase transaction may be completed or started with the customer paying for the goods or services in cash, and the payment terminal 102 is used to subsequently (or in anticipation of a completed purchase transaction) provide the customer with the receipt data.

In example embodiments, a single NFC session pursuant to a first transmit or tap action between the payment terminal 102 and the wireless communication device 104 is used to exchange both the payment information and the receipt data. For example, when the wireless communication device 104 is placed in a position to establish the NFC session with the payment terminal 102, referred to as the first transmit or tap action, the wireless communication device 104 and payment terminal 102 can be configured to keep the NFC session open until the payment terminal 102 provides the wireless communication device 104 with the receipt data in addition to the wireless communication device 104 providing the payment terminal 102 with payment information to complete the purchase transaction.

In example embodiments, multiple NFC sessions between the wireless communication device 104 and payment terminal 102 are required to complete the purchase transaction and for the wireless communication device 104 to receive the receipt data. The multiple NFC sessions can be established by a single transmit action, with the wireless communication device 104 and the payment terminal 102 starting and ending two separate NFC sessions without relative movement between the devices, or multiple NFC sessions can be established via a first transmit action allowing for a first NFC session to be established complete the purchase transaction, and a subsequent second transmit action can establish a second NFC session (separate from the first NFC session) for the wireless communication device 104 to receive the receipt data. For example, the wireless communication device 104 may be required to maintain the wireless communication device 104 and payment terminal 102 in position for a duration long enough to allow for the first NFC session and second NFC session to be completed.

Different applications, executed by a respective processor of the payment terminal 102 and the wireless communication device 104, may be used to manage receipt data and complete purchase transactions. In some example embodiments, the NFC session to receive the receipt data can be established by a receipt agent 108 and a receipt processing agent 112 on the wireless communication device 104 and the payment terminal 102, respectively, while the NFC session to complete the purchase transaction can be established by a payment agent 108 and a payment processing agent 112 on the wireless communication device 104 and the payment terminal 102, respectively. In example embodiments, a single application is responsible for both completing the purchase transaction and managing receipt data on the payment terminal 102 and the wireless communication device 104.

Where multiple applications are used, the respective wireless communication device 104 and the payment terminal 102 can be configured to not share data between themselves. For example, the payment processing agent 112 and the receipt processing agent 112 of the payment terminal 102 can be configured such that receipt data from the receipt processing agent 112 is not accessible by the payment processing agent 112, and similarly payment information available to the payment processing agent 112 may not be accessible to the receipt processing agent 112.

Where the wireless communications device 104 receives the receipt data from the payment terminal 102, the receipt data can be transmitted to a cloud server 116 for storage, or stored on the wireless communication device 104. In example embodiments, the receipt data can be transmitted to the cloud server 116 upon user input at the wireless communication device 104, or based on a set of preconfigured conditions. For multiple applications, the receipt data may be stored to only be accessible to select applications on the wireless communication device 104. For example, the receipt data stored on the wireless device 104 may only be accessible to the receipt agent 108 and not the payment agent 106. In some examples, the cloud server 116 can be accessed over the Internet. In some alternate examples, the cloud server 116 can be another type of server rather than a cloud server. The cloud server 116 can be configured to associate one user account with one or more different payment instrument identifiers.

In an example embodiment, the receipt data is automatically transmitted from the wireless communications device 104 to the cloud server 116 for storage, after receiving by the wireless communications device 104 of the receipt data from the POS terminal 102. In some examples, the user can configure preferences and permissions of the wireless communications device 104 so that the receipt data is automatically transmitted to the cloud server 116 in response to the receipt data being received from the POS terminal 102. In an example, the preferences and permissions can be linked to the particular payment instrument identifier, in which the user can select which payment instrument identifiers can automatically result in the wireless communications device 104 transmitting the receipt data to the cloud server 116.

In example embodiments, the receipt data stored in the cloud server 116 may be accessed from the cloud server 116 over the Internet. In example embodiments, the receipt data may be accessed upon providing authentication information to the cloud server 116. The cloud server 116 can provide authentication information and retrieve receipt data through a web portal, a dedicated application, or the like. In example embodiments, the cloud server 116 can be configured to provide third parties access rights to the receipt data. For example, a user may wish to provide third party access rights to an accountant or government agency in order to comply with tax obligations, or in order to provide backup documentation in the event of an audit or dispute.

In an example embodiment, the wireless communications device 104 or the cloud server 116 can be used to retrieve and display the stored receipts. In some examples, a request to display the stored receipts includes accessing stored receipt data, and generating the receipts in real time. In an example embodiment, the receipts can be sorted or filtered when displayed on the wireless communications device 104. For example, the displayed receipts can be filtered by category, such as “business” versus “personal”. For example, the displayed receipts can be sorted by vendor name, or by date, or by price, etc. The categorization of the receipt data can be performed automatically by the wireless communications device 104 and/or the cloud server 116 in some examples. In other examples, the user can manually provide to the wireless communications device 104 and/or the cloud server 116 the categorization of the receipt data each time the receipt data is being stored.

In some examples, the cloud server 116 can be also be used by the user to store traditional or legacy receipts, such as those received over e-mail or SMS, or scanned versions of paper receipts. For example, the legacy receipt is automatically transmitted from the wireless communications device 104 to the cloud server 116 for storage after receiving the legacy receipt by e-mail or SMS. In another example, the legacy receipt is automatically transmitted from the wireless communications device 104 to the cloud server 116 for storage after detecting of electronic scanning of a printed version of the legacy receipt using a camera or document scanner (not shown) of the wireless communications device 104. Permissions of the wireless communications device 104 can be configured to allocate the applicable preferences and permissions for automatically transmitting the legacy receipt to the cloud server 116 for storage.

In embodiments in which the payment system 100 completes financial transactions, completing the financial transaction may require the payment terminal 102 establish a NFC session with the wireless communication device 104, as described herein. The NFC session may be established by the payment processing agent 110 or otherwise. In example embodiments, other suitable protocols capable of transferring payment information are used to establish a wireless connection between the payment terminal 102 and the wireless communication device 104. The wireless communication device 104 can be configured to, in response to establishing the NFC session with the payment terminal 102, transmit payment information to the payment terminal 102.

In embodiments in which the payment system 100 completes financial transactions, the payment processing agent 110, in response to receiving the payment information, transmits a request for authorization to the payment processing server 114 in order to complete the financial transaction. The request transmitted to the payment processing server 114 includes the payment information received by the payment terminal 102. The request can include a payment instrument identifier (via the payment information), an amount of the purchase transaction and any security information indicating that the user of the payment instrument identifier has approved the request. The request can include further information provided to the payment terminal 102, such as merchant account information, transaction number, and so forth, necessary to receive authorization from the payment processing server 114.

The payment processing server 114 subsequently transmits a message to the payment terminal 102 as to whether the purchase transaction is authorized. In the event that the purchase transaction is authorized, the payment terminal 102 can be configured to transmit, to the wireless communication device 104, confirmation that the purchase transaction is authorized.

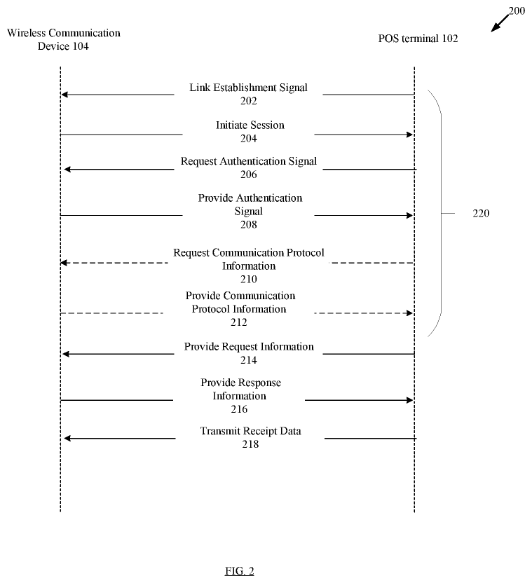

Reference is now made to FIG. 2, which shows a flow diagram showing messages using the payment system of FIG. 1 to receive receipt data in accordance with an example embodiment.

Pursuant to method 200, at step 220, the payment terminal 102 establishes, for example via a communication subsystem 412 as shown in FIG. 4, the NFC session with the wireless communication device 104. Step 220 can include a number of sub-steps.

At step 202, the payment terminal 102 broadcasts a link establishment signal. The link establishment signal may be broadcast by the payment terminal 102 in response to receiving input to do so, or the link establishment signal may be broadcast by payment terminal 102 in response to preconfigured conditions. For example, the link establishment signal may be broadcast by payment terminal 102 where the purchase transaction has been completed and the payment terminal 102 is configured to automatically send receipt data with a second NFC session. In another example, the receipt processing agent 112, as shown in FIG. 1, may direct the payment terminal 102 to broadcast the link establishment signal in response to receiving user input, which input can result from the completion of the purchase transaction with cash (banknotes).

At step 204, the wireless communication device 104 determines that the link establishment signal is within the distance threshold, and transmits a signal to initiate a session. The signal to initiate the session may only be broadcast for a limited range, pursuant to the communication technology or protocol used. The signal to initiate the session may include a NFC identification (NFC ID) of the wireless communication device 104.

At step 206, in some examples, the payment terminal 102 can request authentication. The request for authentication can be sent in response to the payment terminal 102 confirming that the received NFC ID is acceptable. In example embodiments, the request for authentication can require the wireless communication device 104 to again transmit the NFC ID. In example embodiments, the request for authorization includes a transaction ID and a transaction key, to be used by the payment terminal 102 and the wireless communication device 104 to encrypt further communications.

At step 208, in response to receiving the request for the authentication, the wireless communication device 104 transmits the required authentication information to the payment terminal 102. For example, the wireless communication device 104 can transmit an acknowledgement signal encrypted by using the transaction ID or transaction key.

Optionally, at steps 210 and 212, the payment terminal 102 may request that the NFC session be conducted according a particular communication protocol. For example, the payment terminal 102 may transmit a request to communicate via the ISO 7816 or ISO 15693 protocol. At step 212, the wireless communication device 104 may acknowledge the request and provide information allowing the NFC session to establish and utilize the requested protocol. In example embodiments, the wireless communication device 104 transmits the request and the payment terminal 102 determines whether to abide by the request.

At step 214, after the NFC session is established, the payment terminal 102 may transmit a communication that includes a request for information from the wireless communication device 104. The request for information can detail the parameters required by the payment terminal 102 to complete transmission of receipt data. For example, the payment terminal 102 can communicate a request for receipt information which details that a transaction ID of the purchase transaction is required. In example embodiments, the payment terminal 102 is preconfigured with the required parameters, and steps 214 and 216 are not required.

At step 216, the wireless communication device 104 transmits a communication that includes a response to the request for information to the payment terminal 102. The communication that includes the response to the request for information is responsive to the communication received from the payment terminal 102 in step 214. As discussed, for example, the communication that includes the response to the request for information may include a transaction ID of the purchase transaction.

At step 218, the payment terminal 102 transmits a communication that includes the receipt data. In example embodiments, the receipt data is an image of a purchase transaction receipt. Receipt data may include markup language for generating an image of the purchase transaction receipt. According to some embodiments, for example, receipt data comprises a transaction amount, a location of the transaction, and transaction type (credit, debit, etc.), a list of one or more goods or services, a card name (the payment card used to complete the purchase transaction), an account type used to pay (chequing, savings, etc. where applicable), and/or a reference number of the purchase transaction.

As understood in the art, a receipt is a written statement by the merchant that acknowledges the receiving of payment in exchange for the one or more goods or services. As understood in the art, a receipt is not merely a financial transaction log.

In some examples, the receipt data is the receipt itself, e.g., an image of a receipt. In some examples, the wireless communication device 104 can be configured to generate the receipt from the receipt data. In an example, the wireless communication device 104 can include a particular template for visualizing the receipt data into the receipt. In another example, when the receipt data includes the markup language, the markup language is used to generate the receipt from the receipt data. In some examples, the wireless communication device 104 stores only the receipt data. In some examples, the wireless communication device 104 generates the receipt from the receipt data and stores the receipt to the memory 508 (FIG. 5).

In embodiments in which the payment system 100 completes the financial transactions pursuant to a single NFC session, the communication which includes a request for information in step 214 may include payment information. In some embodiments, for example, the wireless communication device 104 can be configured to send the payment information to the payment terminal 102 at step 216 automatically, without the communication including the request in step 214. Where the payment terminal 102 receives payment information from the wireless communication device 104 to complete the purchase transaction, the payment processing agent 112 can be configured to request authorization to complete the purchase transaction from the payment processing server 114, prior to proceeding to step 218.

In embodiments in which the payment system 100 completes financial transactions pursuant to multiple NFC sessions, method 200 may repeated for each NFC session. Each respective communication containing the request for information and the response with information in steps 214 to 216 may be varied, for example in a first instance of method 200, the communication including the request for information may comprise a request for payment information, while the request for information pursuant to a second instance of method 200 may include a communication comprising a request for information which requires a purchase transaction ID.

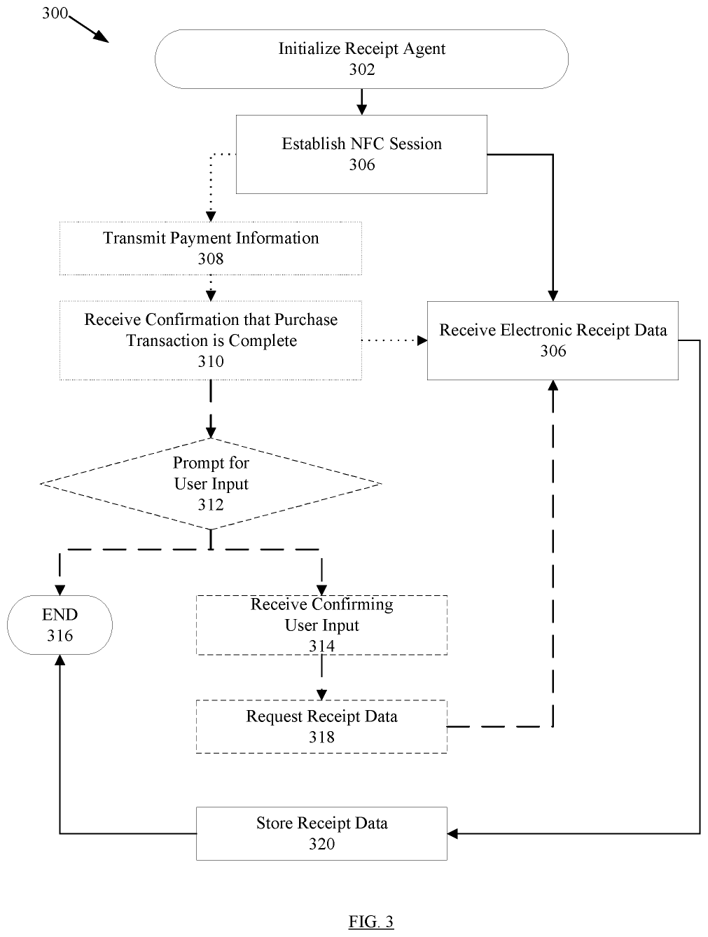

Reference is now made to FIG. 3, which shows a block diagram of processes for a method 300 performed by the wireless communication device 104 of FIG. 1 operating to receive receipt data in accordance with various example embodiments.

At step 302, the receipt agent 108 is initialized. In example embodiments, the receipt agent 108 is running in the background of the wireless communication device 104, and is initialized upon detecting a link establishment signal from the payment terminal 102. The receipt agent 108 may be initialized in response to user input at the wireless communication device 104. In further example scenarios, the receipt agent 108 is initialized upon the wireless communication device 104 detecting being “tapped” towards the payment terminal 102. In example embodiments, the wireless communication device 104 is powered wirelessly, and the receipt agent 108 can initialize as a result of receiving wireless power transmitted by the payment terminal 102.

At step 304, the receipt agent 108 establishes the NFC session with the payment terminal 102. In example embodiments, the receipt agent 108 is solely configured to proceed from step 304 to step 306 and receive receipt data. In some examples, the wireless communication device 104 can be a specialized receipt smart card which is configured to receive and store receipts received from the payment system 100.

At step 306, the receipt agent 108 receives the receipt data. In an example of step 306, the receipt data is automatically received by the receipt agent from the POS terminal 102 after step 304. In an example embodiment, the POS terminal 102 is configured to automatically provide the receipt data to the receipt agent 108. In some examples, the user can configure preferences and permissions so that the receipt data is automatically received in response to the NFC session at step 304 being successfully established. In an example, the preferences and permissions can be linked to the particular payment instrument identifier, in which the user can select which payment instrument identifiers can automatically receive the receipt data in response to the NFC session at step 304 being successfully established.

In an example, the receipt agent 108 can be configured to encrypt the receipt data upon receipt. The key for the encryption is known to the wireless communication device 104. The key can be generated from a person identification number (PIN) that is input by the user through the user interface. In another example, the receipt agent 108 can be configured to sign the receipt data upon receipt, For example, signing can be used for later subsequent verification, auditing or authentication.

An alternate example embodiment of the method 300 is illustrated in FIG. 3 in dotted lines. At step 304, the receipt agent 108, in response to communication with the payment agent 106, or as a result of establishing the NFC session with the payment terminal 102, determines that the purchase transaction is to be completed, the receipt agent 108 proceeds to step 308 to complete the purchase transaction. In example embodiments, when the receipt agent 108 and the payment agent 106 are part of a single application, receipt agent 108 completes steps 308 and 310.

At step 308, the payment agent 106 transmits the payment information to the payment terminal 102 to complete the purchase transaction.

At step 310, the payment agent 106 receives a confirmation that the purchase transaction is complete.

After the purchase transaction is completed at step 310, in some example embodiments, at step 306 the receipt agent 108 receives the electronic receipt data in the same manner as described in detail above. Step 320 is then performed by the receipt agent 108 in the same manner as described in detail above.

Another alternate example embodiment is shown in dashed lines in FIG. 3. In some example embodiments, the receipt agent 108 simply waits for the purchase transaction to be completed by the payment agent 106 prior to proceeding to step 312. At step 312, the receipt agent 108 or the payment agent 106 can be configured to prompt for user input as to whether receipt data is requested.

If the receipt agent 108 or the payment agent 106 does not receive a confirming user input, in some examples, the receipt agent 108 or the payment agent 106 ends at step 316.

At step 314, the receipt agent 108 or the payment agent 106 receives confirming user input. At step 318, in response to receiving the confirming user input in step 312, the receipt agent 108 transmits a request for receipt data to the payment terminal 102. At step 306, the receipt agent 108 receives the receipt data.

At step 320, the receipt agent 108 stores the receipt data. The receipt agent 108 can be configured to encrypt the receipt data prior to storing it. Storing the receipt data can comprise storing the data local to the wireless communication device 104 in the receipt agent 108, storing the data local to the wireless communication device 104 outside of the receipt agent 108, or storing the data remote to wireless communication device 104 (such as sending the data to the cloud server 116), or any combination of storage. For example, the wireless communication device 104 can encrypt data prior to storing it remote to the wireless communication device 104, but not do so for local storage.

At step 316, in some examples, the receipt agent 108 can be configured to terminate, or to remain running in a background state.

In example embodiments, the audio module 428 of the card reader 102 (as shown in FIG. 4) can be configured to, when the receipt data is successfully transmitted, generate and output an audio output through a speaker as a notification. In example embodiments, the audio module 428 can be configured to, when establishing an NFC session and transmitting receipt data is successful, outputting a single audio output through the speaker as a notification. The audio output may be a beeping. In example embodiments, the audio output may be a beeping associated with the establishing or completing of the purchase transaction via NFC.

The wireless communication device 104, via a user interface 422 (as shown in FIG. 4), can be configured to provide any number and type of notifications during the course of managing receipt data. Notifications may be tactile, auditory or visual, such as vibrating, displaying a notification, flashing a light, generating a sound, and so forth.

Referring again to FIG. 3, in example embodiments in which the receipt agent 108 receives confirmation that the purchase transaction is complete, a notification can be generated by the user interface 422 (as shown in FIG. 4) to alert the user of the completion of the purchase transaction. The receipt agent 108 can be configured to provide any combination of notifications described herein when managing receipt data.

The notification may, for example, be a display notification including the prompt for user input, as described in step 312. In example embodiments in which the receipt agent 108 is preconfigured to automatically request receipt data, the notification may include the display notification indicating that the receipt data is not yet received and may include a beeping noise. The indication may comprise a textual warning not to move the wireless communication device 104, a timer, a warning symbol, or otherwise. The receipt agent 108 can be configured to subsequently provide a second notification upon receiving the receipt data. The beeping noise can be a single tone for a specified duration, such has half of one second.

In example embodiments, the receipt agent 108 does not provide a notification prior to receiving the receipt data. For example, the receipt agent 108 can generate a notification indicating that the managing receipt data has commenced (such as a beep or a screen notification), and only provide a notification (such as a beep, or vibration) upon receiving the receipt data.

Reference is now made to FIG. 4, which shows a block diagram illustrating an example payment terminal 102 in accordance with example embodiments. The payment terminal 102 can directly communicate with the wireless communication device 104. The payment terminal 102 includes at least one processor 402 that controls the overall operation of the payment terminal 102. The processor 402 is coupled to a plurality of components via a communication bus (not shown) which provides a communication path between the components and the processor 402. The payment terminal 102 may also include any one of or any combination of Random Access Memory (RAM) 404, Read Only Memory (ROM) 406, a persistent (non-volatile) memory 408 which may be flash erasable programmable read only memory (EPROM) (“flash memory”) or other suitable form of memory. The payment terminal 102 may also include a data port 410 such as a serial data port (e.g., Universal Serial Bus (USB) data port), a communication subsystem 412, and a real-time clock (RTC) 414.

The communication subsystem 412 includes a NFC subsystem 432 which includes devices, associated circuits and components for providing NFC communication. Other example short range communication subsystems may include devices, associated circuits and components for providing various types of short-range wireless communication such as Bluetooth(™), RFID (radio frequency identification), IEEE 802.15.3a (also referred to as UltraWideband (UWB)), Z-Wave, ZigBee, ANT/ANT+ or infrared (e.g., Infrared Data Association (IrDA) communication).

In example embodiments, the communication subsystem 412 includes any combination of a long-range wireless communication subsystems, and a wired communication subsystem (e.g., Ethernet or the like). The long-range wireless communication subsystem includes one or more radio frequency (RF) transceivers for communicating with a radio access network (e.g., cellular network). The RF transceivers may communicate with any one of a plurality of fixed transceiver base stations of a cellular network within its geographic coverage area. The long-range wireless communication subsystem may also include a wireless local area network (WLAN) transceiver for communicating with a WLAN via a WLAN access point (AP). The WLAN may include a Wi-Fi wireless network that conforms to Institute of Electrical and Electronics Engineers (IEEE) 802.11x standards (sometimes referred to as Wi-Fi(R)) or other communication protocol.

The communication subsystem 412 of the payment terminal 102 may include one or more antennas, a processor such as a digital signal processor (DSP), and local oscillators (LOs). The specific design and implementation of the communication subsystem 412 is dependent upon the communication technologies implemented by the payment terminal 102. Data received by the payment terminal 102 may be decompressed and decrypted by a decoder (not shown).

Operating system software 416 executed by the processor 402 is stored in the persistent memory 408 but may be stored in other types of memory devices, such as ROM 406 or similar storage element. A number of applications 418 executed by the processor 402 are also stored in the persistent memory 408. The applications 418 may include the receipt processing agent 112, responsible for managing receipt data, and a payment processing agent 110, responsible for completing purchase transactions. Data 420 can be used to store data relied upon or collected by the applications. Other applications are also stored in the memory 408. The receipt processing agent 112 and the payment processing agent 110, when executed by the processor 402, allow the payment terminal 102 to perform the methods described herein.

As described herein, the receipt processing agent 112 can be operated by the payment terminal 102 while other applications are in operation, running in the background. In some embodiments, for example, the receipt processing agent 112 may be configured to be able to collect data from other running applications, and use the collected data to carry out the methods described herein. Similarly, the receipt processing agent 112 may be configured to be prevent other applications from accessing data within the purview of the receipt processing agent 112. For example, the transmitting of the receipt data may occur without the receipt data being provided to the payment processing agent 112, and therefore without the receipt data being transmitted through to the payment processing server 114.

The payment terminal 102 also includes a user interface 422. The user interface 422 may include a plurality of modules for receiving user input or notifying a user. For example, the user interface 422 may include any one of a display module 424, a printer module 426, an audio module 428 for receiving and generating audio, a keypad module 430, a tactile feedback module (not shown) or other physical feedback modules, independently or in any combination, for interacting with and receiving user input.

In some examples, the display module 424 is a touchscreen. In some examples, a card reader module 434 is configured for extracting payment information from the wireless communication device 104 having a magnetic strip. The card reader module 434 can also include an RFID reader or smart chip reader that can be configured with NFC communication protocol, to receive the payment information from the wireless communication device 104.

Reference is now to FIG. 5, which shows a block diagram illustrating an example wireless communication device 104 in accordance with example embodiments. The wireless communication device 104 is for communicating with the payment terminal and, in some examples, the cloud server 116. The wireless communication device 104 includes at least one processor 502 that controls the overall operation of the wireless communication device 104. The processor 502 is coupled to a plurality of components via a communication bus (not shown) which provides a communication path between the components and the processor 502. The wireless communication device 104 may also include any one of or any combination of Random Access Memory (RAM) 504, Read Only Memory (ROM) 506, a persistent (non-volatile) memory 508 which may be flash erasable programmable read only memory (EPROM) (“flash memory”) or other suitable form of memory. The wireless communication device 104 may also include a data port 510 such as a serial data port (e.g., Universal Serial Bus (USB) data port), and a communication subsystem 512. The memory 508 can be used to store the receipt data. In some examples, the memory 508 can be used to store a receipt generated from the receipt data.

In example embodiments, the wireless communication device 104 can be a specialized receipt smart card which is configured to receive and store receipts. The smart card can include a chip that includes the flash memory, the processor 502 and the communication subsystem 512.

In some examples, the memory 508 can be also be used by the wireless communication device 104 to store traditional or legacy receipts, such as those received over e-mail or SMS, or scanned versions of paper receipts.

In example embodiments, the wireless communication device 104 is a mobile computing device, such as a mobile phone, tablet, computer table, or the like.

The communication subsystem 512 includes a short-range communication subsystem which includes devices, associated circuits and components for providing NFC communication. The short range communication subsystem may include devices, associated circuits and components for providing various types of short-range wireless communication such as Bluetooth(™), RFID (radio frequency identification), IEEE 802.15.3a (also referred to as UltraWideband (UWB)), Z-Wave, ZigBee, ANT/ANT+ or infrared (e.g., Infrared Data Association (IrDA) communication).

In example embodiments, the communication subsystem 512 includes any combination of a long-range wireless communication subsystems, and a wired communication subsystem (e.g., Ethernet or the like). The long-range wireless communication subsystem includes one or more radio frequency (RF) transceivers for communicating with a radio access network (e.g., cellular network). The RF transceivers may communicate with any one of a plurality of fixed transceiver base stations of a cellular network within its geographic coverage area. The long-range wireless communication subsystem may also include a wireless local area network (WLAN) transceiver for communicating with a WLAN via a WLAN access point (AP). The WLAN may include a Wi-Fi wireless network that conforms to Institute of Electrical and Electronics Engineers (IEEE) 802.11x standards (sometimes referred to as Wi-Fi(R)) or other communication protocol.

The communication subsystem 512 of the wireless communication device 104 may include one or more antennas, a processor such as a digital signal processor (DSP), and local oscillators (LOs). The specific design and implementation of the communication subsystem 512 is dependent upon the communication technologies implemented by the wireless communication device 104. Data received by the wireless communication device 104 may be decompressed and decrypted by a decoder (not shown).

Operating system software 516 executed by the processor 502 is stored in the persistent memory 508 but may be stored in other types of memory devices, such as ROM 508 or similar storage element. A number of applications 514 executed by the processor 502 are also stored in the persistent memory 508. The applications 514 may include the receipt agent 108, responsible for managing receipt data, and the payment agent 106, responsible for completing purchase transactions. Data 518 can be used to store data relied upon or collected by the applications. Other applications are also stored in the memory 508. The receipt agent 108 and the payment agent 106, when executed by the processor 502, allow the wireless communication device 104 to perform the methods described herein.

As described herein, the receipt agent 108 can be operated by the wireless communication device 104 while other applications are in operation, running in the background. In some embodiments, for example, the receipt agent 108 may be configured to be able to collect data from other running applications, and use the collected data to carry out the methods described herein. Similarly, the receipt agent 108 may be configured to be prevent other applications from accessing data within its purview. For example, the storing of the receipt data may occur without the receipt data being provided to the payment agent 106.

The wireless communication device 104 also includes a user interface 520. The user interface 520 may include a plurality of modules for receiving user input or notifying a user. For example, the user interface 520 may include any one of a display module 522, an audio module 524, for receiving and generating audio, a keypad module 526, a tactile feedback module (not shown) or other physical feedback modules, independently or in any combination, for interacting with and receiving user input. In some examples, the display module 522 is a touchscreen.

The steps and/or operations in the flowcharts and drawings described herein are for purposes of example only. There may be many variations to these steps and/or operations. For instance, the steps may be performed in a differing order, or steps may be added, deleted, or modified.

The coding of software for carrying out the above-described methods described is within the scope of a person of ordinary skill in the art having regard to the example embodiments. Machine-readable code executable by one or more processors of one or more respective devices to perform the above-described method may be stored in a machine-readable medium such as the memory of the data manager. The terms “software” and “firmware” are interchangeable and include any computer program stored in memory for execution by a processor, comprising Random Access Memory (RAM) memory, Read Only Memory (ROM) memory, EPROM memory, electrically EPROM (EEPROM) memory, and non-volatile RAM (NVRAM) memory. The above memory types are examples only, and are thus not limiting as to the types of memory usable for storage of a computer program.

All values and sub-ranges within disclosed ranges are also disclosed. Also, although the systems, devices and processes disclosed and shown herein may include a specific plurality of elements, the systems, devices and assemblies may be modified to include additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

The example embodiments are described at least in part in terms of methods, such that a person of ordinary skill in the art will understand that the example embodiments may also be directed to the various elements for performing at least some of the aspects and features of the described methods, be it by way of hardware, software or a combination thereof. Accordingly, the technical solution of the described embodiments may be embodied in a non-volatile or non-transitory machine-readable medium (e.g., optical disk, flash memory, etc.) having stored thereon executable instructions tangibly stored thereon that enable a processing device to execute examples of the methods disclosed herein.

The term “processor” may include any programmable system comprising systems using microprocessors/controllers or nanoprocessors/controllers, digital signal processors (DSPs), application specific integrated circuits (ASICs), field-programmable gate arrays (FPGAs) reduced instruction set circuits (RISCs), logic circuits, and any other circuit or processor configured to execute the functions described herein. The term “database” may refer to either a body of data, a relational database management system (RDBMS), or to both. As used herein, a database may include any collection of data comprising hierarchical databases, relational databases, flat file databases, object-relational databases, object oriented databases, and any other structured collection of records or data that is stored in a computer system. The above examples are example only, and thus are not intended to limit in any way the definition and/or meaning of the terms “processor” or “database”.

The example embodiments are described with reference to the accompanying drawings, in which the embodiments are shown. However, many different embodiments may be used, and thus the description should not be construed as limited to the embodiments set forth herein. Rather, these embodiments are provided so that this disclosure will be thorough and complete. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except if indicated otherwise either explicitly or inherently by context.

The example embodiments may be embodied in other specific forms without departing from the subject matter of the claims. The described example embodiments are to be considered in all respects as being only illustrative and not restrictive. The example embodiments intend to cover and embrace all suitable changes in technology. The scope of the example embodiments is, therefore, described by the appended claims rather than by the foregoing description. The scope of the claims should not be limited by the embodiments set forth in the examples, but should be given the broadest interpretation consistent with the description as a whole.

What is claimed is:

1. A system comprising;
a payment terminal including a comprising:
a communication subsystem including a Near Field Communication (NFC) subsystem;
a memory; and
a processor in communication with the communication subsystem and the memory and configured to:
complete a purchase transaction,
establish, through the communication subsystem, a NFC session, and
transmit, through the NFC session, receipt data of a receipt for the purchase transaction.

2. The system of claim 1, wherein the processor is further configured to:
receive payment information for the completing the purchase transaction;
transmit, to a payment processor via the communication subsystem, the payment information for the complete the purchase transaction; and
receive, via the communication subsystem, a confirmation that the purchase transaction is authorized from the payment processor.

3. The system of claim 2, wherein the processor is further configured to receive the payment information during a first NFC session, and transmit the receipt data during a second NFC session, separate from the first NFC session.

4. The system of claim 2, wherein the transmitting of the receipt data is not transmitted via the payment processor.

5. The system of claim 1, wherein the payment terminal further comprises a speaker, and the processor is further configured to output an audio output through the speaker in response to the receipt data being successfully transmitted.

6. The system of claim 1, wherein the payment terminal further comprises a speaker, and the processor is further configured to output an audio output through the speaker in response to establishing the NFC session.

7. The system of claim 1, wherein the NFC session is established with a wireless communication device.

8. A system comprising:
a wireless communication device including:
a communication subsystem,
a memory; and
a processor in communication with the communication subsystem and the memory and configured to:
establish, with a payment terminal, a Near Field Communication (NFC) session via the communication subsystem,
receive, from the payment terminal, receipt data of a receipt of a purchase transaction through the NFC session, and
store the receipt data in the memory.

9. The system of claim 8, wherein the processor is further configured to, in order to establish the NFC session, detect whether the communication subsystem is within a threshold distance of the payment terminal.

10. The system of claim 8, wherein the processor is further configured to:
transmit, to the payment terminal via the communication subsystem, payment information to complete the purchase transaction; and
receive, via the communication subsystem, a confirmation that the purchase transaction is authorized from the payment terminal.

11. The system of claim 8, wherein the processor is further configured to generate the receipt from the receipt data, wherein the storing the receipt data includes storing the receipt.

12. The system of claim 8, wherein the receipt data is the receipt.

13. The system of claim 8, wherein the NFC session is established with a payment terminal.

14. The method of claim 8, wherein the wireless communication device is a smart card having a chip that includes the memory, the processor and the NFC subsystem.

15. A method performed by a wireless communication device, comprising:
establishing, with a payment terminal, a Near Field Communication (NFC) session;
receiving, from the payment terminal, receipt data of a receipt of a purchase transaction through the NFC session; and
storing the receipt data in memory of the wireless communication device.

16. The method of claim 15, wherein the establishing of the NFC session includes detecting whether the wireless communication device is within a threshold distance of the payment terminal.

17. The method of claim 15, further comprising:
transmitting, to the payment terminal, payment information in order to complete the purchase transaction; and
receiving a confirmation that the purchase transaction is authorized from the payment terminal.

18. The method of claim 17, wherein the transmitting the payment information is performed during a first NFC session, and the transmitting the request for the receipt data is performed during a second NFC session separate from the first NFC session.

19. The method of claim 17, further comprising transmitting the receipt data to a cloud server.

20. The method of claim 17, wherein the receipt data includes an image of the receipt.

21. The method of claim 17, wherein the receipt data includes markup language data for generating an image of the receipt.

22. The method of claim 17, wherein the receipt data comprises a transaction amount, a transaction location, a transaction type, a list of one or more goods or services, a card name, an account type, and a reference number.

23. The method of claim 17, wherein the receipt data is stored separate from a payment application which stores the payment information.

24. The method of claim 17, further comprising encrypting the receipt data prior to storing the receipt data.

25. The method of claim 17, further comprising generating the receipt from the receipt data, wherein the storing the receipt data includes storing the receipt.

26. The method of claim 17, wherein the wireless communication device is a smart card having a chip that includes the memory, a processor and a NFC subsystem.

27. A method performed by a payment terminal, comprising:
completing a purchase transaction;
establishing, through a communication subsystem, a Near Field Communication (NFC) session; and
transmitting, through the NFC session, receipt data of a receipt for the purchase transaction.

28. The method of claim 27, wherein the NFC session is established with a wireless communication device.

29. The method of claim 27, wherein the completing the purchase transaction comprises:
receiving, from a wireless communication device, payment information;
transmitting, to a payment processor, the payment information; and
receiving, from the payment processor, confirmation that the purchase transaction is authorized.

30. The method of claim 27, wherein the receiving the payment information is performed during a first NFC session, and the transmitting the receipt data is performed during a second NFC session, separate from the first NFC session.

31. The method of claim 27, wherein the receipt data comprises a transaction amount, a transaction location, a transaction type, a list of one or more goods or services, a card name, an account type, and a reference number.

32. The method of claim 27, wherein the receipt data transmitted to the wireless communication device is receipt data that is immediately available to be output by the payment terminal.

33. The method of claim 27, further comprising, in response to the receipt data being successfully transmitted, outputting an audio output through a speaker.

34. The method of claim 27, further comprising, in response to successfully establishing the NFC session and transmitting the receipt data, outputting an audio output through a speaker.

35. The method of claim 27, wherein the purchase transaction includes a banknote transaction.
